(19) United States
(12) Patent Application Publication
(10) Pub. No.: US 2019/0215208 A1
(43) Pub. Date: Jul. 11, 2019

(54) WIRELESS COMMUNICATION DEVICE AND TIME AND FREQUENCY SYNCHRONIZATION METHOD OF THE SAME

(71) Applicant: INSTITUTE FOR INFORMATION INDUSTRY, Taipei (TW)

(72) Inventors: Juinn-Horng DENG, Taoyuan City (TW); Chia-Fang LEE, Miaoli County (TW); Tsung-Yu TSAI, Tainan City (TW)

(21) Appl. No.: 15/871,036

(22) Filed: Jan. 14, 2018

(30) Foreign Application Priority Data
Jan. 9, 2018 (TW) 107100806

(51) Int. Cl. H04L 27/26; H04J 11/00; H04L 5/00

(52) U.S. Cl. CPC H04L 27/2613; H04J 11/0079; H04J 11/0076; H04J 2011/002; H04L 5/0051; H04L 5/0007; H04J 2011/0016; H04J 11/0073

(57) ABSTRACT

A time and frequency synchronization method that includes the steps outlined below is provided. A wireless signal from a base station is received. The wireless signal is delayed on a time domain and is further correlated with the original wireless signal to generate a delayed and correlated signal. Primary symbols related to a primary synchronization signal are delayed and are further correlated with the original primary symbols to generate delayed and correlated primary symbols. The delayed and correlated signal and the delayed and correlated primary symbols are correlated to identify the position of the primary synchronization signal based on a primary peak value. The position of the secondary synchronization signal is identified based on the position of the primary synchronization signal.

### RELATED APPLICATIONS

This application claims priority to Taiwan Application Serial Number 107100806, filed Jan. 9, 2018, which is herein incorporated by reference.

### BACKGROUND

### Field of Invention

The present disclosure relates to a wireless communication technology. More particularly, the present disclosure relates to a wireless communication device and a time and frequency synchronization method of the same.

### Description of Related Art

When a wireless communication device performs communication with a base station, a time and frequency synchronization procedure is required. In 5G communication technology in the future, a communication system with high reliability and low latency is necessary. Take the requirement of low latency as an example, the point to point communication latency is required to be within 1 millisecond when 5G technology is used. As a result, the time and frequency synchronization between the wireless communication device and the base station needs to be quickly accomplished under the condition that the high reliability is maintained.

Accordingly, what is needed is a wireless communication device and a time and frequency synchronization method of the same to address the issues mentioned above.

### SUMMARY

An aspect of the present disclosure is to provide a time and frequency synchronization method that includes the steps outlined below. A wireless signal is received from a base station. The wireless signal on a time domain is delayed and is correlated with the original wireless signal to generate a delayed and correlated signal. A plurality of primary symbols related to a primary synchronization signal are delayed and are correlated with the original primary symbols to generate a plurality of delayed and correlated primary symbols. The delayed and correlated signal and the delayed and correlated primary symbols are correlated to identify a position of the primary synchronization signal based on a primary peak value. The position of the secondary synchronization signal is identified based on the position of the primary synchronization signal.

Another aspect of the present disclosure is to provide a wireless communication device that includes a storage module and a processing module. The storage module is configured to store a plurality computer executable command. The processing module is coupled to the storage module and is configured to execute the commands to perform a time and frequency synchronization method that includes the steps outlined below. A wireless signal is received from a base station. The wireless signal on a time domain is delayed and is correlated with the original wireless signal to generate a delayed and correlated signal. A plurality of primary symbols related to a primary synchronization signal are delayed and are correlated with the original primary symbols to generate a plurality of delayed and correlated primary symbols. The delayed and correlated signal and the delayed and correlated primary symbols are correlated to identify a position of the primary synchronization signal based on a primary peak value. The position of the secondary synchronization signal is identified based on the position of the primary synchronization signal.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a diagram of a wireless communication device in an embodiment of the present disclosure;

FIG. 2 is a flow chart of a time and frequency synchronization method in an embodiment of the present invention; and

FIG. 3 is a flow chart of a time and frequency synchronization method in an embodiment of the present invention.

### DETAILED DESCRIPTION

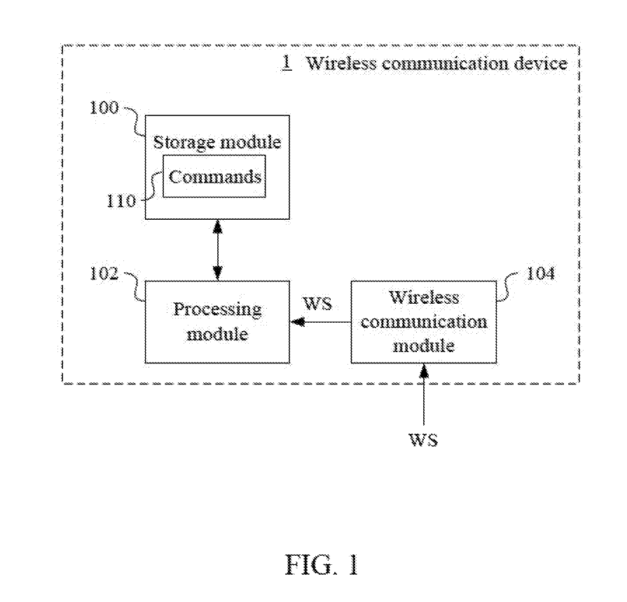

Reference is made to FIG. 1. FIG. 1 is a diagram of a wireless communication device 1 in an embodiment of the present disclosure. In an embodiment, the wireless communication device 1 is a handheld mobile communication device such as, but not limited to a smartphone or a tablet personal computer (PC) and is able to perform wireless communication with a base station (not illustrated). When the wireless communication device 1 starts to connect to the base station, the wireless communication device 1 and the base station can perform the communication correctly through the time and frequency synchronization procedure.

The wireless communication device 1 includes a storage module 100 and a processing module 102.

The processing module 102 is coupled to the storage module 100. The processing module 102 can be various kinds of processors that have the ability to perform data operation. Further, the processing module 102 can perform data transmission with the modules described above through various data transmission paths.

The storage module 100 is configured to store a plurality computer executable command. In different embodiments, the storage module 100 can be such as, but not limited to a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains.

It is appreciated that the components mentioned above is exemplarily described. In other embodiments, the wireless communication device 1 may include other types of components.

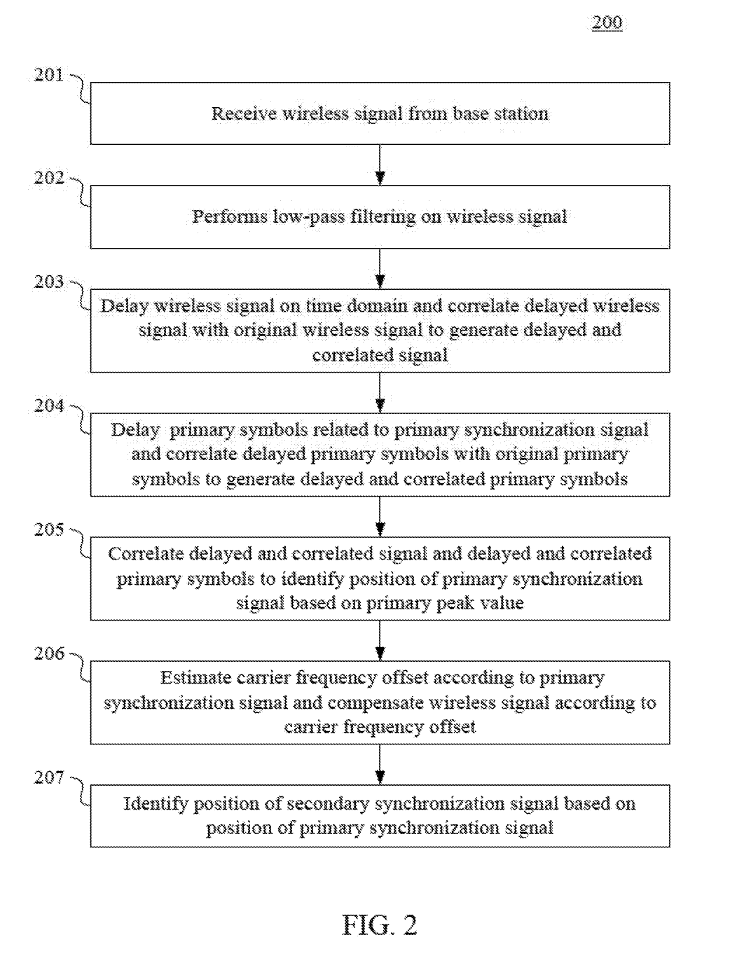

Reference is now made to FIG. 2. FIG. 2 is a flow chart of a time and frequency synchronization method 200 in an embodiment of the present invention. The time and frequency synchronization method 200 can be used in the wireless communication device 1 illustrated in FIG. 1, or be implemented by using other hardware components such as a database, a common processor, a computer, a server, other unique hardware devices that have a specific logic circuit or an equipment having a specific function, e.g. a unique hardware integrated by a computer program and a processor or a chip.

More specifically, the time and frequency synchronization method 200 is implemented by using a computer program to control the modules in the wireless communication device 1. The computer program can be stored in a non-transitory computer readable medium such as a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains.

The time and frequency synchronization method 200 performed by the processing module 102 during the operation of the wireless communication device 1 is described in the following paragraphs.

The time and frequency synchronization method 200 includes the steps outlined below (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 201, the processing module 102 receives a wireless signal WS from a base station.

In an embodiment, the processing module 102 substantially receives the wireless signal WS through a wireless communication module 104 included in the wireless communication device 1.

In step 202, the processing module 102 performs a low-pass filtering on the wireless signal WS.

In an embodiment, the wireless signal WS includes a primary synchronization signal (PSS) and a secondary synchronization signal (SSS). By identifying the positions of the primary synchronization signal and the secondary synchronization signal of the wireless signal WS, the information included in the primary synchronization signal and the secondary synchronization signal can be determined to synchronize the wireless communication device 1 and the base station.

The primary synchronization signal is usually located in a specific frequency range. As a result, by performing an appropriate band-pass filtering on the wireless signal WS, the interference of the other wide bandwidth noise can be avoided.

In step 203, the processing module 102 delays the wireless signal WS on a time domain and correlates the delayed wireless signal WS with the original wireless signal WS to generate a delayed and correlated signal WSDC (not labeled in the figure).

In an embodiment, the delayed and correlated signal WSDC is a[n], the original wireless signal is r[n] and a relation between the delayed and correlated signal WSDC and the original wireless signal WS is a[n]=r[n]×conj{r[n−k]}, wherein k is an integer. In different embodiments, the value of k can be adjusted according to practical applications.

In step 204, the processing module 102 delays a plurality of primary symbols related to the primary synchronization signal and correlates the delayed primary symbols with the original primary symbols to generate a plurality of delayed and correlated primary symbols.

In an embodiment, the primary synchronization signal is retrieved from a finite sequence set. Each of the primary symbols included therein is an orthogonal frequency-division multiplexing symbol (OFDM symbol). In an embodiment, the primary synchronization signal has three kinds of primary symbols that are known. As a result, in step 204, each of the three kinds of primary symbols are delayed and correlated.

In step 205, the processing module 102 correlates the delayed and correlated signal WSDC and the delayed and correlated primary symbols to identify a position of the primary synchronization signal based on a primary peak value.

In an embodiment, based on sampling, the processing module 102 can retrieve the signal sequence of the wireless signal WS along the timing sequence and further perform such as, but not limited to a calculation of sliding correlation on these signal sequences according to the three kinds of the OFDM symbols to identify the OFDM symbol of the primary synchronization signal on the time domain.

However, since the delayed and correlated signal WSDC is generated according to correlation operation performed on the wireless signal WS in step 203, the correlation operation in the step 204 is required to be performed on the three kinds of the known OFDM symbols such that the operation of the sliding correlation is performed subsequently with the delayed and correlated signal WSDC to identify the position of the primary synchronization signal on the time domain.

In an embodiment, after the calculation of the sliding correlation, a maximum value is obtained. The maximum value is the primary peak value of the corresponding to the position of the primary synchronization signal. As a result, the processing module 102 can determine the position of the primary synchronization signal according to the position of the primary peak value.

In an embodiment, the processing module 102 further detects a sector ID of the base station according to the position of the primary synchronization signal.

In step 206, the processing module 102 estimates a carrier frequency offset (CFO) according to the primary synchronization signal and compensates the wireless signal WS according to the carrier frequency offset.

In an embodiment, the carrier frequency offset includes an integer CFO (ICFO) and/or a fractional CFO (FCFO). The processing module 102 can retrieve a coarse CFO according to the phase of the peak value of the primary synchronization signal and compensate the wireless signal WS according to the coarse CFO subsequently to retrieve another peak value of the primary synchronization signal. The two peak values are correlated to retrieve a more precise CFO to perform a more precise compensation on the wireless signal WS. However, the method described above is merely an example. The present invention is not limited thereto.

In step 207, the processing module 102 identifies the position of the secondary synchronization signal based on the position of the primary synchronization signal.

The time and frequency synchronization method 200 of the present invention performs a low-pass filtering on the wireless signal WS to avoid the interference of other wide bandwidth noises and performs operations of delaying and correlating on the time domain to identify the primary synchronization signal quickly to avoid the effect of the carrier frequency offset and the Doppler effect in the time-varying channel. Further, the secondary synchronization signal can be identified according to the primary synchronization signal to accomplish the synchronization of the time and frequency.

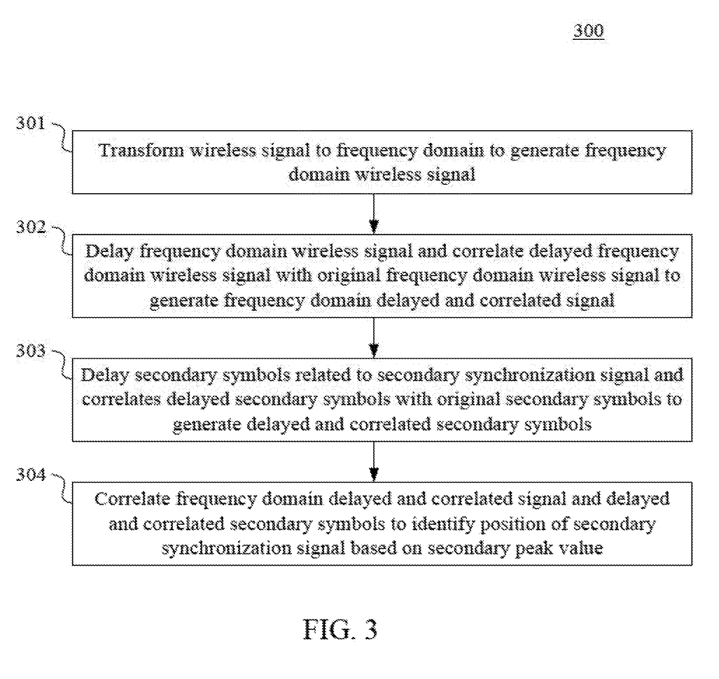

Reference is now made to FIG. 3, a flow chart of a time and frequency synchronization method 300 in an embodiment of the present invention. The time and frequency synchronization method 200 can be used in the wireless communication device 1 illustrated in FIG. 1, or be implemented by using other hardware components such as a database, a common processor, a computer, a server, other unique hardware devices that have a specific logic circuit or an equipment having a specific function, e.g. a unique hardware integrated by a computer program and a processor or a chip.

More specifically, the time and frequency synchronization method 300 is implemented by using a computer program to control the modules in the wireless communication device 1. The computer program can be stored in a non-transitory computer readable medium such as a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains.

The time and frequency synchronization method 300 performed by the processing module 102 during the operation of the wireless communication device 1 is described in the following paragraphs.

The time and frequency synchronization method 300 can be used in the step 207 of the time and frequency synchronization method 200 to identify the position of the secondary synchronization signal based on the position of the primary synchronization signal. The time and frequency synchronization method 300 includes the steps outlined below (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 301, the processing module 102 transforms the wireless signal WS to a frequency domain to generate a frequency domain wireless signal WSF (not labeled in the figure).

In step 302, the processing module 102 delays the frequency domain wireless signal WSF and correlates the delayed frequency domain wireless signal WSF with the original frequency domain wireless signal WSF to generate a frequency domain delayed and correlated signal WSFDC (not labeled in the figure).

In step 303, the processing module 102 delays a plurality of secondary symbols related to the secondary synchronization signal and correlates the delayed secondary symbols with the original secondary symbols to generate a plurality of delayed and correlated secondary symbols.

Similar to the primary synchronization signal, the secondary synchronization signal is retrieved from a finite sequence set. Each of the secondary symbols included therein is an orthogonal frequency-division multiplexing symbol (OFDM symbol). In an embodiment, the secondary synchronization signal has over twenty kinds of secondary symbols that are known. As a result, in step 303, each of the secondary symbols are delayed and correlated.

In step 304, the processing module 102 correlates the frequency domain delayed and correlated signal WSFDC and the delayed and correlated secondary symbols to identify the position of the secondary synchronization signal based on a secondary peak value.

In an embodiment, based on sampling, the processing module 102 can retrieve the signal sequence of the frequency domain wireless signal WSF along the timing sequence and further perform such as, but not limited to a calculation of sliding correlation on these signal sequences according to the OFDM symbols to identify the OFDM symbol of the secondary synchronization signal on the time domain.

However, since the frequency domain delayed and correlated signal WSFDC is generated according to correlation operation performed on the wireless signal WS in step 302, the correlation operation in the step 303 is required to be performed on the known OFDM symbols such that the operation of the sliding correlation is performed subsequently with the frequency domain delayed and correlated signal WSFDC to identify the position of the secondary synchronization signal on the frequency domain.

In an embodiment, after the calculation of the sliding correlation, a maximum value is obtained. The maximum value is the secondary peak value of the corresponding to the position of the secondary synchronization signal. As a result, the processing module 102 can determine the position of the secondary synchronization signal according to the position of the secondary peak value.

In an embodiment, the processing module 102 further detects a cell ID of the base station according to the secondary synchronization signal.

The advantage of the present invention is to transform the wireless signal WS to the frequency domain and perform the operation of delaying and correlating to avoid the effect of the delay spread and the multi-path channel to identify the secondary synchronization signal quickly to accomplish the synchronization of the time and frequency.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A time and frequency synchronization method comprising:
receiving a wireless signal from a base station;
delaying the wireless signal on a time domain and correlating the delayed wireless signal with the original wireless signal to generate a delayed and correlated signal;
delaying a plurality of primary symbols related to a primary synchronization signal and correlating the delayed primary symbols with the original primary symbols to generate a plurality of delayed and correlated primary symbols;
correlating the delayed and correlated signal and the delayed and correlated primary symbols to identify a position of the primary synchronization signal based on a primary peak value; and
identifying the position of the secondary synchronization signal based on the position of the primary synchronization signal.

2. The time and frequency synchronization method of claim 1, wherein after receiving the wireless signal further comprises:
performing a low-pass filtering on the wireless signal.

3. The time and frequency synchronization method of claim 1, further comprising:
detecting a sector ID of the base station according to the primary synchronization signal.

4. The time and frequency synchronization method of claim 1, wherein the delayed and correlated signal is a[n], the original wireless signal is r[n] and a relation between the delayed and correlated signal and the original wireless signal is a[n]=r[n]×conj{r[n−k]}, wherein k is an integer.

5. The time and frequency synchronization method of claim 1, wherein each of the primary symbols is an orthogonal frequency-division multiplexing symbol (OFDM symbol).

6. The time and frequency synchronization method of claim 1, wherein the step of identifying the position of the secondary synchronization signal further comprises:
transforming the wireless signal to a frequency domain to generate a frequency domain wireless signal;
delaying the frequency domain wireless signal and correlating the delayed frequency domain wireless signal with the original frequency domain wireless signal to generate a frequency domain delayed and correlated signal;
delaying a plurality of secondary symbols related to the secondary synchronization signal and correlating the delayed secondary symbols with the original secondary symbols to generate a plurality of delayed and correlated secondary symbols;
correlating the frequency domain delayed and correlated signal and the delayed and correlated secondary symbols to identify the position of the secondary synchronization signal based on a secondary peak value.

7. The time and frequency synchronization method of claim 6, wherein before transforming the wireless signal to the frequency domain further comprises:
estimating a carrier frequency offset (CFO) according to the primary synchronization signal;
compensating the wireless signal according to the carrier frequency offset.

8. The time and frequency synchronization method of claim 6, further comprising:
detecting a cell ID of the base station according to the secondary synchronization signal.

9. A wireless communication device, comprising:
a storage module configured to store a plurality computer executable commands; and
a processing module coupled to the storage module and configured to execute the commands to perform a time and frequency synchronization method that comprises:
receiving a wireless signal from a base station;
delaying the wireless signal on a time domain and correlating the delayed wireless signal with the original wireless signal to generate a delayed and correlated signal;
delaying a plurality of primary symbols related to a primary synchronization signal and correlating the delayed primary symbols with the original primary symbols to generate a plurality of delayed and correlated primary symbols;
correlating the delayed and correlated signal and the delayed and correlated primary symbols to identify a position of the primary synchronization signal based on a primary peak value; and
identifying the position of the secondary synchronization signal based on the position of the primary synchronization signal.

10. The wireless communication device of claim 9, wherein after receiving the wireless signal further comprises:
performing a low-pass filtering on the wireless signal.

11. The wireless communication device of claim 9, wherein the time and frequency synchronization method further comprises:
detecting a sector ID of the base station according to the primary synchronization signal.

12. The wireless communication device of claim 9, wherein the delayed and correlated signal is a[n], the original wireless signal is r[n] and a relation between the delayed and correlated signal and the original wireless signal is a[n]=r[n]×conj{r[n−k]}, wherein k is an integer.

13. The wireless communication device of claim 9, wherein each of the primary symbols is an orthogonal frequency-division multiplexing symbol (OFDM symbol).

14. The wireless communication device of claim 9, wherein the step of identifying the position of the secondary synchronization signal further comprises:
transforming the wireless signal to a frequency domain to generate a frequency domain wireless signal;
delaying the frequency domain wireless signal and correlating the delayed frequency domain wireless signal with the original frequency domain wireless signal to generate a frequency domain delayed and correlated signal;
delaying a plurality of secondary symbols related to the secondary synchronization signal and correlating the delayed secondary symbols with the original secondary symbols to generate a plurality of delayed and correlated secondary symbols;
correlating the frequency domain delayed and correlated signal and the delayed and correlated secondary symbols to identify the position of the secondary synchronization signal based on a secondary peak value.

15. The wireless communication device of claim 14, wherein before transforming the wireless signal to the frequency domain further comprises:
estimating a carrier frequency offset (CFO) according to the primary synchronization signal;
compensating the wireless signal according to the carrier frequency offset.

16. The wireless communication device of claim 14, wherein the time and frequency synchronization method further comprises:
detecting a cell ID of the base station according to the secondary synchronization signal.
